(19) United States
(12) Patent Application Publication
(10) Pub. No.: US 2017/0194801 A1
(43) Pub. Date: Jul. 6, 2017

(54) ELECTRICITY STORAGE DEVICE USING HIGH-PRESSURE GAS MEDIUM AND METHOD THEREOF

(71) Applicant: Po-Ying Chen, Kaohsiung City (TW)

(72) Inventors: Po-Ying Chen, Kaohsiung (TW); I-Chin Chen, Kaohsiung (TW); I-Hsi Chen, Kaohsiung (TW)

(21) Appl. No.: 14/987,743

(22) Filed: Jan. 4, 2016

(51) Int. Cl. H02J 7/00

(52) U.S. Cl. CPC H02J 7/0042; H02J 7/0052

(57) ABSTRACT

An electricity storage device uses a high-pressure gas medium to store electricity from a power supply having a positive electrode and a negative electrode. The storage device includes a body unit, an electric charge storage unit, and a charge/discharge unit. The body unit comprises a case by which a containment space is surrounded and defined. The electric charge storage unit is disposed in the containment space and comprises a Class 1 gas and a Class 2 gas. The Class 1 gas is an insulator, while the Class 2 gas is a conductor. The charge/discharge unit is disposed in the containment space and comprises a positive component connected to the positive electrode of the power supply, and a negative component connected to the negative electrode of the power supply. The positive and negative components are interleaved with each other, so that electricity from the power supply is stored by the electric charge storage unit.

### BACKGROUND OF THE INVENTION

1. Field of the Invention

The present invention relates to an electricity storage device, and more particularly to an electricity storage device using a high-pressure gas medium and a related method thereof.

2. Description of the Related Art

With continuous technological advances, it is hard to live without electrical appliances in daily life. Many electrical appliances can be directly charged through plugs, but the most common way is to use separable batteries. However, the reactive substances used in most batteries are corrosive pollutants, and the environment is impacted by disposable batteries. With the recent rise in environmental awareness, rechargeable batteries are preferred by most people.

Even though typical rechargeable batteries can be recharged many times, the reactive substances are still corrosive pollutants. Taking the lead acid battery as an example, its positive electrode is a lead dioxide plate, its negative electrode is a lead plate, and its electrolyte contains about 30% to 40% of a dilute sulphuric acid solution; if attention is not paid to the liquid level height of the dilute sulphuric acid solution, a dangerous situation can occur, and when the charge voltage is too high, flammable hydrogen can be produced. Additionally, the lead acid battery can lead to heavy metal contamination of the environment at every stage of the production and recycling process, and moreover is a threat to human health. Furthermore, the density of the electrolyte is between 1.24 and 1.30 g/cm³, and its total weight is heavier, and so it is not suitable for use in lightweight and portable electrical appliances.

Therefore, reducing the impact on the environment by current electricity storage devices, while lowering the total weight of the electricity storage device, and improving the life span of the electricity storage device, are objectives many in the field are seeking to achieve.

### SUMMARY OF EMBODIMENTS OF THE INVENTION

Therefore, an objective of an embodiment of the present invention is to provide an electricity storage device using a high-pressure gas medium comprising a body unit, an electric charge storage unit, and a charging/discharging unit.

The body unit comprises a case by which a containment space is surrounded and defined.

The electric charge storage unit is disposed in the containment space, comprising a Class 1 gas and a Class 2 gas, the Class 1 gas being an insulator, while the Class 2 gas is a conductor.

The charging/discharging unit is disposed in the containment space, and comprises a positive component connected to a positive electrode of the power supply, and a negative component connected to a negative electrode of the power supply. The positive and negative components are spaced from each other, so the electrical power can be stored by the electric charge storage unit.

Another technique of an embodiment of the present invention is that the body unit comprises a heating unit by which the electric charge storage unit in the containment space is heated.

Another technique of an embodiment of the present invention is that a density of the gases is between 0.1 and 1.0 g/cm³.

Another technique of an embodiment of the present invention is that the body unit further comprises at least a dielectric component disposed in the containment space. The dielectric component is a non-metallic material, and when electricity is stored by the electric charge storage unit, a plurality of micro pores are created in the dielectric component.

Another technique of an embodiment of the present invention is that the positive component is provided with a positive charge plate region, and a plurality of positive charge conducting regions are configured on the surface of the positive charge plate region; the negative component is provided with a negative charge plate region, and a plurality of negative charge conducting regions are configured on the surface of the negative charge plate region.

Another technique of an embodiment of the present invention is that the electric charge storage unit further comprises a Class 3 noble gas.

Another technique of an embodiment of the present invention is that the Class 1 gas is selected from a set consisting of carbon dioxide, methane, ethane, propane, chloromethane, chloroethane, chloropropane and combinations thereof. The Class 2 gas is selected from a set consisting of water, methanol, ethanol, propanol and combinations thereof. The Class 3 gas is selected from a set consisting of nitrogen, helium, argon and combinations thereof.

Another technique of an embodiment of the present invention is that the volume percentage of the Class 1 gas is from 20% to 80%, the volume percentage of the Class 2 gas is from 19.99% to 79%, and the volume percentage of the Class 3 gas is from 0.01% to 1%.

Another objective of an embodiment of the present invention is to provide an electricity storage method using a high-pressure gas medium comprising a filling step, a charging step, and an electricity providing step.

First, in the filling step, an electric charge storage unit is filled into a case by which a containment space is surrounded and defined. The electric charge storage unit comprises an insulating Class 1 gas and a conducting Class 2 gas.

Then, in the charging step, a positive component disposed in the containment space and a negative component spaced with respect to the positive component are respectively connected to positive and negative electrodes of a power supply, so that electrical power is stored by the electric charge storage unit in the containment space.

Finally, in the electricity providing step, through the positive and negative components, the electricity stored in the electric charge storage unit in the containment space is externally delivered for use.

Another technique of an embodiment of the present invention is that in the filling step, the electric charge storage unit further comprises a Class 3 noble gas.

An advantage of embodiments of the invention is that the electric charge storage unit provided with the Class 1 and Class 2 gases is filled in the containment space, and a density of gas in the containment space is between 0.1 and 1.0 g/cm³, so that the electrolyte is lighter than those used in conventional rechargeable batteries with the same volume, and the environmental impact of the Class 1 and Class 2 gases is minimal.

### BRIEF DESCRIPTION OF THE DRAWINGS

FIG. 1 is a schematic drawing depicting a first preferred embodiment according to the present invention;

FIG. 2 is a schematic drawing depicting an electric charge storage unit of a first preferred embodiment;

FIG. 3 is a schematic drawing depicting a second preferred embodiment of the present invention;

FIG. 4 is a transmission electron microscopy image depicting a plurality of micro pores inside a dielectric component of the second preferred embodiment;

FIG. 5 is a schematic drawing depicting a third embodiment according to the present invention; and

FIG. 6 is a flow chart depicting a fourth embodiment according to the present invention.

### DETAILED DESCRIPTION OF THE PREFERRED EMBODIMENTS

Specific structural and functional details disclosed herein will become apparent from the following description of the four preferred embodiments of the present invention taken in conjunction with the accompanying drawings.

Before explaining the present invention in detail, it is to be understood that similar elements are labeled with the same reference numbers.

In various embodiments of the present invention, electricity is stored via the mediums of two gases, under the high-pressure conditions, in which one is an insulating gas, while the other is a conducting gas. Normally, under the high-pressure conditions, there are polar molecules in the conducting gas, and non-polar molecules are in the insulating gas. A polar molecule has a large electronegativity difference between atoms on two sides. Electronegativity, one chemical characteristic of the atom, is used to describe the tendency of an atom to attract a bonding pair of electrons; the larger the electronegativity is, the stronger the tendency is. When the electronegativity difference occurs in different elements, the uneven dispersion also occurs in the bonding pair of the electron cloud. The polar molecule is a molecule that has partial positive charge on one side and partial negative charge on the other, and so under the high-pressure conditions, the atoms on the positive charge end of the molecule will attract the negative end of another; water, by way of example, can exhibit such characteristics. Moreover, the bonding strength of attraction between polar molecules formed by the polar characteristic may be only a bit more than the van der Waals force, and with the likes dissolve likes rule, as well as all the atoms in the polar molecule structure arranged in a small layer, in consideration of the above three factors, under high-pressure conditions, the polar molecules with similar one-atom thick structure can present in a lamellar phase to disperse. Similarly, under high-pressure condition, when the lamellar phase structure of the polar molecules is determined actively, the non-polar molecules are also presented in a lamellar phase to disperse, but it is determined passively, and the only difference from the polar molecule layer is that the attraction between the molecules is obtained by the van der Waals force.

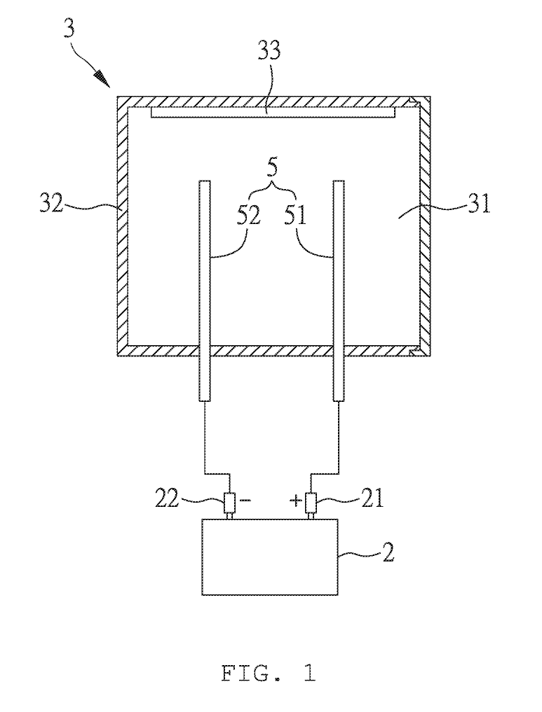

With reference to FIG. 1, a first preferred embodiment according to an embodiment of the present invention is depicted by which an electricity storage device using a high-pressure gas medium is provided and is used to store electricity from a power supply 2 with a positive electrode 21 and a negative electrode 22, and comprises a body unit 3, an electric charge storage unit 4, and a charging/discharging unit 5.

The body unit 3 comprises a case 32 by which a containment space 31 is surrounded and defined, and a heating unit 33 by which the air in the containment space 31 is heated. In the first embodiment, the shape of the case 32 is square or rectangular and made from high pressure resistant materials. It will be appreciated that circular or curved shapes may be used for the case 32 as well, and so should not be construed as limiting the invention; in practice, the case 32 should be designed to resist higher pressures within the containment space 31. In the first preferred embodiment, the inner surface of the case 32 and the surface of the heating unit 33 are made from insulating materials, and so the electric charge in the containment space 31 is prevented from being conducted to the outside by the case 32 or by the heating unit 33, from which lower charge efficiencies would otherwise occur.

The electric charge storage unit 4 is disposed in the containment space 31, comprising a Class 1 gas 41, a Class 2 gas 42, and a Class 3 gas 43. The Class 1 gas 41 is an insulator, the Class 2 gas 42 is a conductor, while the Class 3 gas 43 is a noble gas.

Because the Class 1 gas 41 and the Class 2 gas 42 are the primary structures for providing electricity storage in the containment space 3, the ratio of the Class 1 gas 41 and Class 2 gas 42 in the containment space 31 is one to one. The Class 3 gas 43 is provided in a molecular state to assist in improving the electric charge storage capacity, so that it is not necessary to have too much, percentage-wise, in the containment space 31. Preferably, the volume percentage of the Class 1 gas 41 is from 20% to 80%, the Class 2 gas 42 is from 19.99% to 79%, and the Class 3 gas 43 is from 0.01% to 1%.

Furthermore, the Class 1 gas 41 is preferably selected from a set consisting of carbon dioxide, methane, ethane, propane, chloromethane, chloroethane, chloropropane and combinations thereof. The Class 2 gas is preferably selected from a set consisting of water, methanol, ethanol, and propanol or combinations thereof. The Class 3 gas is preferably selected from a set consisting of nitrogen, helium, and argon or combinations thereof. The substances (including the Class 1 gas 41, the Class 2 gas 42 and the Class 3 gas 43) in the containment space 31 are heated by the heating unit 33 by which the electric charge storage unit 4 is provided in a gaseous state, and a gas density within the containment space 31 is between 0.1 and 1.0 g/cm³. It is well-known to those of ordinary skill in the art to heat a liquid to create a corresponding gas and remain in a predetermined pressure range, and so details related to this are not explained further herein.

The charging/discharging unit 5 is disposed in the containment space 31, and comprises a positive component 51 connected to the positive electrode 21 of the power supply 2, and a negative component 52 connected to the negative electrode 22 of the power supply 2. The positive and negative components 51, 52 are separated from each other by an interval, so the electricity from the power supply 2 is stored by the electric charge storage unit 4.

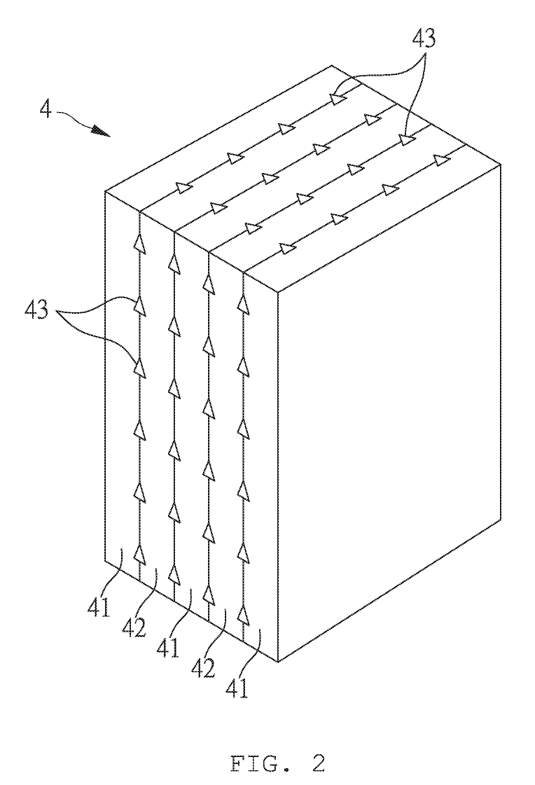

With reference to FIG. 2, when electricity from the power supply 2 is delivered to the electric charge storage unit 4, because of different polarities, the Class 1 gas 41 forms a plurality of ultra-thin insulating laminar surfaces, the Class 2 gas 42 forms as a plurality of ultra-thin conducting laminar surfaces, and the plural insulating laminar surfaces and the plural conducting laminar surfaces are alternately disposed, so that a capacitive structure is obtained by the arrangement of alternately disposed conducting layers in the containment space 31. Hence, when the containment space is pressurized, the lamellar phases 42 are formed by the conducting gas, and the insulating gas is passively filled in as a lamellar phase 41, so that the gases in the containment space form a series arrangement of insulator 41-conductor 42-insulator 41-conductor 42.

Furthermore, the Class 3 gas 43 at reduced percentages presented in an atomic state is attached between adjacent insulating laminar 41 surfaces and conducting laminar surfaces 42. The Class 3 gas 43 can be regarded as an interface to increase the superficial area by which electronic occupancy is provided to increase the electric charge storage capacity; however, the Class 3 gas 43 is optional and need not be added in all embodiments, but instead recharging is simply performed by the Class 1 and Class 2 gases 41, 42.

It was found by the inventor that the small amounts of the Class 3 gas 43 are added to increase by 3 to 7 times the recharging capacity. Hence, in practice, the Class 3 gas 43 is optional, and electricity from the power supply 2 is stored only by the Class 1 and Class 2 gases 41, 42.

It is notable that when electricity is provided by the power supply 2, the insulating laminar surface and conducting laminar surface are self-formed instantly, and their thickness is only as thick as several atoms to form an excellent capacitive structure, so that their excellent charging and discharging characteristics are provided.

In the first preferred embodiment, the gas pressure in the containment space 31 can also exceed the critical pressure of the Class 1 and Class 2 gases 41, 42. The temperature in the containment space 31 heated by the heating unit 33 can also exceed the critical temperature of the Class 1 and Class 2 gases 41, 42, so that the Class 1 and Class 2 gases 41, 42 in the containment space 31 are provided in a supercritical fluid state. In general, a supercritical fluid is compressible and exhibits diffusion just like a gas, and also exhibits fluidity like a liquid. Furthermore, a density of the supercritical fluid is usually also between 0.1 to 1.0 g/ml.

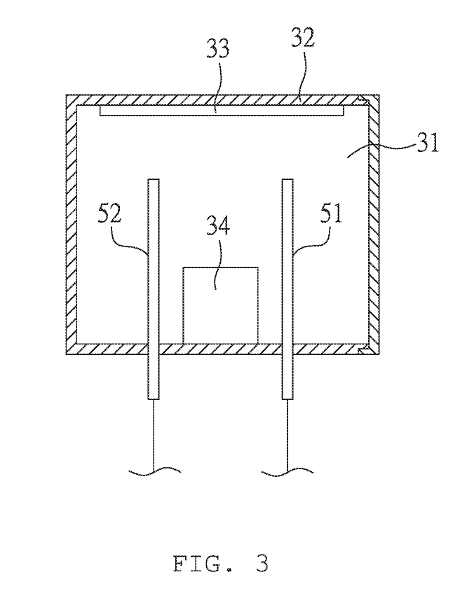

With reference to FIG. 3, a second preferred embodiment according to an embodiment of the present invention is depicted which is similar to the first embodiment, and so common features are not described again. A difference is that the body unit 3 further comprises at least a dielectric component 34 disposed in the containment space 31. The dielectric component 34 is a non-metallic material, and preferably plastic, rubber or any other suitable high polymer material. When electricity from the power supply 2 is stored by the electric charge storage unit 4, a plurality of micro pores 341 are created on the dielectric component 34 by electric charge stored in the electric charge storage unit 4.

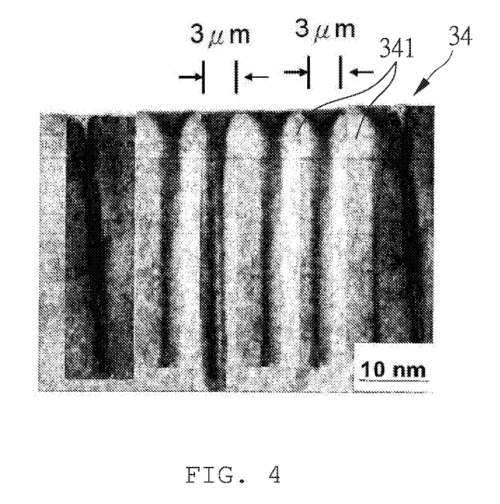

FIG. 4 is a transmission electron microscopy image, showing the plurality of micro pores 341 with a width of around 3 nm inside the dielectric component 34, which increase by several times the charge storage capacity and stabilizes the discharging process of the electric charge storage unit 4 to provide another location for electric charge to rest, so that it can improve the charging and discharging efficiencies.

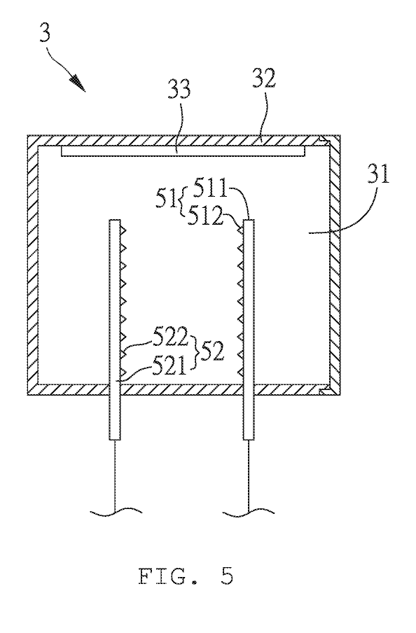

With reference to FIG. 5, a third preferred embodiment according to an embodiment of the present invention is depicted, which is similar to the first embodiment, and so common features are not described again. A difference is that the positive component 51 is provided with a positive charge plate region 511, and a plurality of positive charge conducting regions 512 are configured on the surface of the positive charge plate region 511; the negative component 52 is provided with a negative charge plate region 521, and a plurality of negative charge conducting regions 522 are configured on the surface of the negative charge plate region 521. The positive charge conducting region 512 and negative charge conducting region 522 are electrically connected to the Class 2 gas 42 in the containment space 31.

Notably, the plurality of positive and negative charge conducting regions 511, 512 of the third preferred embodiment are sharp-edged configurations, and respectively disposed on the surface of the positive and negative charge plate regions 511, 521. In the electricity charging and discharging process, the sharp points will discharge and are electrically connected to the plurality of conducting laminar surfaces created by the Class 2 gas. Another charging and discharging arrangement is provided by the foregoing method to increase the universality of the present invention.

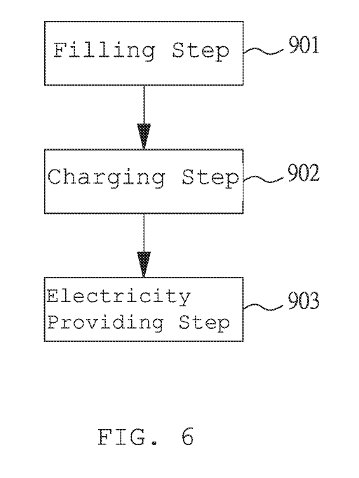

With reference to FIG. 6, a fourth preferred embodiment according to an embodiment of the present invention is depicted. The fourth preferred embodiment uses the aforementioned electricity storage device, comprising a filling step 901, a charging step 902, and an electricity providing step 903.

First, in the filling step 901, an electric charge storage unit 4 is disposed within and fills a case 32 by which a containment space 31 is surrounded and defined. The electric charge storage unit 4 comprises an insulating Class 1 gas 41, a conducting Class 2 gas 42, and a noble Class 3 gas 43.

The Class 1 gas 41, Class 2 gas 42 and Class 3 gas 43 are heated by the heating unit 33 by which the electric charge storage unit 4 is urged into a gaseous or a supercritical fluid state, and a gas density of the containment space 31 is between 0.1 and 1.0 g/cm³. Because the expansion coefficient of each type of gas is different, having different gas densities at different temperatures, in practice the heated temperature is calculated according to the gas classification.

Then, in the charging step 902, a positive component 51 disposed in the containment space 31 and a negative component 52 spaced from the positive component 51 are respectively connected to positive and negative electrodes 21, 22 of a power supply 2, so that electricity from the power supply 2 is stored by the electric charge storage unit 4 in the containment space 31.

At the moment electricity is provided by the power supply 2, because of the different polarities of the electric charge, the plurality of insulating laminar surfaces and conducting laminar surfaces self-form alternately within the electric charge storage unit 4, and their thickness is only as thick as a few atoms to form an excellent capacitive structure, providing excellent charging and recharging characteristics.

The equation for calculating capacitance is expressed as:

C=(∈A)/d,

where

C is the capacitance, ∈ is the dielectric constant of the dielectric material, A is the area of the laminar surface, and d is the distance between adjacent laminar surfaces.

The equation for calculating the maximum charge capacity is expressed as:

Q=n(C*V),

where

Q is the maximum electrical charge of the device, two conducting laminar surfaces B are adjacent to be a conducting laminar surface set, N is the number of conducting laminar surface sets, C is capacitance and V is the voltage.

Because each conducting laminar surface is ultra-thin, when the value of d is small, the value of C is larger, and thus the value of Q is larger.

Finally, in the electricity providing step 903, through the positive and negative components 51, 52, electricity stored in the electric charge storage unit 4 in the containment space 31 is delivered externally for use. Because the laminar surfaces in the containment space 31 are ultra-thin, the stored electric charge is delivered externally for use by the tunneling effect, usage of embodiments of the present invention is the same as in typical storage batteries, which are well-known to those of ordinary skill in the art, and no further explanation is provided herein.

It is notable that this invention replaces the electrolyte used in typical storage batteries with a zero pollution, high-pressure gas, and when electricity is delivered into the containment space 31 by the charging/discharging unit 5, the ultra-thin insulating laminar surfaces and conducting laminar surfaces are formed by the Class 1 gas 41 and Class 2 gas 42 in a supercritical state due to the different polarities, and arranged in an alternating manner to form an excellent capacitive structure, so that a charging capacity thousands to ten thousand of times greater than typical rechargeable batteries can be obtained.

For example, typical lead acid batteries have a charge capacity of about 2,000 mAh, and an output voltage of about 12±0.1 V, while with the case 32 with the same volume, an embodiment the device of the present invention has a charge capacity of about 40,000,000 mAh, and an output voltage of about 4.5±0.3 V, in which the best charge capacity is adjusted by a way of an added Class 3 gas 43. Although the output voltage of embodiments of the present invention is lower than typical electric batteries, in practice, the desired electrical characteristics can be obtained by way of series and/or parallel connections or by connecting a boost converter according to requirements.

Although some energy provided by the electricity storage device is used to keep the Class 1 and Class 2 gases 41, 42 in a gaseous or supercritical fluid state, if the gas in the containment space 31 is heated by a portion of the electricity taken from the charging process, a self-sufficient electricity supply can be obtained, and an electricity storage device having a huge capacity can be obtained to greatly enhance industrial applicability.

Furthermore, electric charge is stored in the electrodes of typical lead acid batteries, and so the provided electricity is restricted by the speed of the chemical reaction. Therefore, conventional storage batteries have limits on the maximum output or input electricity. In contrast, the electric charge is stored and delivered directly by way of a capacitor in embodiments of the present invention, and so a large amount of electricity is provided instantly for output electricity, while the charging voltage can be increased to speed up charging times when storing electricity.

In conclusion, the electrolyte of conventional rechargeable batteries is replaced with a high-pressure gas in the electricity storage device to efficiently reduce pollution and weight. Through an excellent capacitive structure formed by the arrangement of disposing the plurality of ultra conducting layers at an interval in the containment space 31, the maximum charge capacity and instant discharging capacity are increased, so that the objectives of the present invention can be obtained.

The foregoing detailed description is merely in relation to four preferred embodiments and shall not be construed as limiting the invention. It is to be understood that many other possible modifications and variations can be made without departing from the spirit and scope of the invention as hereinafter claimed.

What is claimed is:

1. An electricity storage device using a high-pressure gas medium to store electricity from a power supply with a positive electrode and a negative electrode, comprising:
a body unit defining and surrounding a containment space;
an electric charge storage unit disposed in the containment space, comprising a Class 1 gas and a Class 2 gas, the Class 1 gas being an insulator, the Class 2 gas being a conductor; and
a charging/discharging unit disposed in the containment space, comprising a positive component connected to a positive electrode of the power supply, and a negative component connected to a negative electrode of the power supply, wherein the positive and negative components are spaced from each other so that electricity from the power supply is stored by the electric charge storage unit.

2. The electricity storage device as claimed in claim 1, wherein the body unit comprises a heating unit configured to heat the electric charge storage unit in the containment space.

3. The electricity storage device as claimed in claim 2, wherein a density of the gases in the containment space is between 0.1 and 1.0 g/cm³.

4. The electricity storage device as claimed in claim 3, wherein the body unit further comprises at least a dielectric component disposed in the containment space, wherein the dielectric component is a non-metallic material, and wherein when electricity stored in the electric charge storage unit, a plurality of micro pores are created on the dielectric component.

5. The electricity storage device as claimed in claim 4, wherein the positive component is provided with a positive charge plate region, and a plurality of positive charge conducting regions are disposed on the surface of the positive charge plate region; and the negative component is provided with a negative charge plate region, and a plurality of negative charge conducting regions are disposed on the surface of the negative charge plate region.

6. The electricity storage device as claimed in claim 5, wherein the electric charge storage unit further comprises a Class 3 noble gas.

7. The electricity storage device as claimed in claim 6, wherein the Class 1 gas is selected from a set consisting of carbon dioxide, methane, ethane, propane, chloromethane, chloroethane, chloropropane and combinations thereof; the class 2 gas is selected from a set consisting of water, methanol, ethanol, propanol and combinations thereof; and the class 3 gas is selected from a set consisting of nitrogen, helium, argon and combinations thereof.

8. The electricity storage device as claimed in claim 7, wherein a volume percentage of the Class 1 gas is from 20% to 80%, the volume percentage of the Class 2 is from 19.99% to 79%, and the volume percentage of the Class 3 gas is from 0.01% to 1%.

9. An electricity storage method using a high-pressure gas medium, the method comprising:
a filling step, wherein an electric charge storage unit fills a containment space, the electric charge storage unit comprising an insulative Class 1 gas and a conductive Class 2 gas;
a charging step, wherein a positive component disposed in the containment space and a negative component spaced from the positive component are respectively connected to positive and negative electrodes of a power supply, so that electricity from the power supply is stored by the electric charge storage unit in the containment space; and
an electricity providing step, wherein through the positive and negative components, electricity stored in the electric charge storage unit in the containment space is delivered externally for use.

10. The electricity storage method as claimed in claim 9, wherein in the filling step, the electric charge storage unit further comprises a Class 3 noble gas.
